(19) United States
(12) Patent Application Publication
(10) Pub. No.: US 2024/0355517 A1
(43) Pub. Date: Oct. 24, 2024

(54) SOFT MAGNETIC ALLOY MATERIAL AND INDUCTOR USING THE SAME

(71) Applicant: SAMSUNG ELECTRO-MECHANICS CO., LTD., Suwon-si (KR)

(72) Inventors: Seongjae Lee, Suwon-si (KR); Jongho Chung, Suwon-si (KR); Jihoon Hwang, Suwon-si (KR); Jihye Kim, Suwon-si (KR); Byung Soo Kang, Suwon-si (KR); Chin Mo Kim, Suwon-si (KR)

(73) Assignee: SAMSUNG ELECTRO-MECHANICS CO., LTD., Suwon-si (KR)

(21) Appl. No.: 18/606,566

(22) Filed: Mar. 15, 2024

(30) Foreign Application Priority Data
Apr. 18, 2023 (KR) 10-2023-0050828

(51) Int. Cl. H01F 1/153; H01F 27/245; H01F 27/29

(52) U.S. Cl. CPC H01F 1/15308; H01F 1/15333; H01F 1/15341; H01F 27/245; H01F 27/29

(57) ABSTRACT

A soft magnetic alloy material includes nanocrystals and amorphous phase and includes Fe (iron), Co (cobalt), and P (phosphorus), wherein the soft magnetic alloy material is represented by Composition Formula 1, when an average content of Co in the amorphous phase is Co(a) (at %) and an average content of Co in the nanocrystal, Co(c)−Co(a)>0, Composition Formula 1: FeₐCo_{b}P_{c}M_{d}, in Composition Formula 1, a, b, c, and d represent an atomic percentage content (at %) of corresponding elements, respectively, 0<a≤90, 0<b≤20, 0<c≤10, 0<d≤20, and a+b+c+d=100, and M includes Si, B, Cu, Cr, C, Ni, Al, Mn, Ag, Zn, Sn, As, Sb, Bi, N, O, S, or a combination thereof.

### CROSS-REFERENCE TO RELATED APPLICATION

This application claims priority to and the benefit of Korean Patent Application No. 10-2023-0050828 filed in the Korean Intellectual Property Office on Apr. 18, 2023, the entire contents of which are incorporated herein by reference.

### BACKGROUND

The present disclosure relates to a soft magnetic alloy material and an inductor using the same.

In recent times, as electronic devices have been down-sized and more highly integrated, a power supply voltage has been lowered, and accordingly, a current value has been increased to transmit the same power. Accordingly, a metal inductor maintaining inductor performance even at a high current has been applied, but recently, in order to secure the use at a further higher current, a material having high current characteristics, that is, a material having a high magnetic saturation (Ms) value has been applied.

In conventional Fe-based soft magnetic materials, electromagnetic properties are improved by increasing the content of elements such as Nb to control a size of nanocrystals in the material. However, when the content of elements such as Nb is increased, which reduces a content of metals such as Fe, there was a problem that it is difficult to improve the Ms value.

In addition, when the content of metals such as Fe is excessively high, the Ms value may be increased, but there is another problem that the nanocrystals locally grow during the heat treatment. Accordingly, this problem results in growth of non-uniform crystals, deteriorating the electromagnetic properties of the soft magnetic material.

### SUMMARY

One aspect of embodiments provides a soft magnetic alloy material capable of maintaining high magnetic saturation characteristics while improving an amorphous rate of an initial alloy and improving electromagnetic properties. Another aspect of embodiments provides an inductor using the soft magnetic alloy material.

However, problems to be solved by the embodiments are not limited to the above-described problems and may be variously expanded within the range of technical ideas included in the embodiments.

The soft magnetic alloy material according to some embodiments may include nanocrystals and amorphous phase, include Fe (iron), Co(cobalt), and P (phosphorus), is represented by Composition Formula 1, and when an average content of Co in the amorphous phase is Co(a) (at %) and an average content of Co in the nanocrystal are Co(c) (at %), Co(c)−Co(a)>0:

FeₐCo_{b}P_{c}M_{d} Composition Formula 1
wherein in Composition Formula 1, a, b, c, and d represent an atomic 0<b≤20, 0<c≤10, 0<d≤20, a+b+c+d=100, and M includes Si, B, Cu, Cr, C, Ni, Al, Mn, Ag, Zn, Sn, As, Sb, Bi, N, O, S, or a combination thereof.

The soft magnetic alloy material according to some embodiments may satisfy P(a)−P(c)>0, when an average P content in the amorphous phase is P(a) (at %) and an average P content in the nanocrystal is P(c) (at %).

In some embodiments, the soft magnetic alloy material may satisfy 0.4≤Co(c)−Co(a)≤1.5.

In some embodiments, the soft magnetic alloy material may satisfy the 0.5≤P(a)−P(c)≤2.5.

In Composition Formula 1, b may be 2≤b≤16.

In Composition Formula 1, c may be 1≤c≤6.

In Composition Formula 1, M may not include Nb.

An average crystal size of the nanocrystal may be less than or equal to about 20 nm.

A soft magnetic alloy material according to another embodiment may include nanocrystals and amorphous phase, and Fe (iron), Co(cobalt), and P (phosphorus), may be represented by Composition Formula 1, and when an average P content in the amorphous phase is P(a) (at %) and an average P content in the nanocrystal is P(c) (at %), may satisfy P(a)−P(c)>0:

FeₐCo_{b}P_{c}M_{d} Composition Formula 1
wherein in Composition Formula 1, a, b, c, and d represent an atomic 0<b≤20, 0<c≤10, 0<d≤20, a+b+c+d=100, and M includes Si, B, Cu, Cr, C, Ni, Al, Mn, Ag, Zn, Sn, As, Sb, Bi, N, O, S, or a combination thereof.

The soft magnetic alloy material according to some embodiments may satisfy Co(c)−Co(a)>0, when an average content of Co in the amorphous phase is Co(a) (at %), and an average content of Co in the nanocrystal.

In some embodiments, the soft magnetic alloy material may satisfy, 0.5≤P(a)−P(c)≤2.5.

In some embodiments, the soft magnetic alloy material may satisfy 0.4≤Co(c)−Co(a)≤1.5.

In Composition Formula, b may be 2≤b≤16.

In Composition Formula, c may be 1≤c≤6.

In Composition Formula, M may not include Nb.

An average crystal size of the nanocrystal may be less than or equal to about 20.

A method of preparing a soft magnetic alloy material according to some embodiments may include (1) mixing raw materials; (2) melting the mixed raw materials; (3) preparing an amorphous soft magnetic alloy by rapidly cooling the molten raw materials; and (4) heat-treating the amorphous soft magnetic alloy.

An amorphous rate of the amorphous soft magnetic alloy may be greater than or equal to about 95%.

An inductor according to some embodiments may include a body including a magnetic material including a soft magnetic alloy material; a coil in the body; and an external electrode on the outer surface of the body,
wherein, the soft magnetic alloy material may include nanocrystals and amorphous phase, may include Fe (iron), Co(cobalt), and P (phosphorus), and may be represented by Composition Formula 1,
the soft magnetic alloy material satisfies Co(c)−Co(a)>0 when an average content of Co in the amorphous phase is Co(a) (at %) and an average content of Co in the nanocrystal, or
the soft magnetic alloy material satisfies P(a)−P(c)>0 when an average P content in the amorphous phase is P(a) (at %) and an average P content in the nanocrystal is P(c) (at %).

FeₐCo_{b}P_{c}M_{d} Composition Formula 1
in Composition Formula 1, a, b, c, and d represent an atomic percentage content (at %) of corresponding elements, respectively, 0<a≤90, 0<b≤20, 0<c≤10, 0<d≤20, a+b+c+d=100, and
M includes Si, B, Cu, Cr, C, Ni, Al, Mn, Ag, Zn, Sn, As, Sb, Bi, N, O, S, or a combination thereof.

The coil may include a support member and an upper coil and a lower coil respectively on upper and lower surfaces of the support member, and the upper coil and the lower coil may be electrically connected through vias penetrating the support member.

The body may include a mold portion; a cover portion on one surface of the mold portion; and a core protruding from one surface of the mold portion, wherein the coil may be between one surface of the mold portion and the cover portion, and the core may penetrate through the coil.

The body may include a plurality of magnetic sheets including the magnetic material.

According to the soft magnetic alloy material according to some embodiments, the amorphous rate of the initial alloy can be improved and high magnetic saturation characteristics can be maintained while improving electromagnetic properties.

However, the various advantageous advantages and effects of the present disclosure are not limited to the above descriptions, and will be more easily understood in the process of describing specific embodiments of the present disclosure.

### BRIEF DESCRIPTION OF THE DRAWINGS

FIG. 1 is a TEM photograph and a graph showing a line profile by spot quantitative analysis through TEM analysis of a soft magnetic alloy material according to an embodiment.

FIG. 2 is a TEM photograph and a graph showing a line profile by spot quantitative analysis through TEM analysis of a soft magnetic alloy material according to an embodiment.

FIGS. 3 to 6 are graphs showing amorphous rates of the amorphous soft magnetic alloys according to the content (at %) of Co metal.

FIG. 7 is a perspective view of an inductor according to an embodiment.

FIG. 8 is a cross-sectional view schematically illustrating an incision surface in the direction I-I′ of FIG. 7.

FIG. 9 is an enlarged view of region A of FIG. 8.

FIG. 10 is a perspective view of an inductor according to another embodiment.

FIG. 11 is a cross-sectional view schematically illustrating an incision surface in a direction II-II′ of FIG. 10.

FIG. 12 is a perspective view of an inductor according to another embodiment.

FIG. 13 is a cross-sectional view schematically illustrating an incision surface in a direction II-III′ of FIG. 12.

### DETAILED DESCRIPTION OF THE EMBODIMENTS

Hereinafter, various embodiments of the present disclosure will be described in detail with reference to the accompanying drawings so that those skilled in the art may easily carry out the present disclosure. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction,” which corresponds to an L-axis direction in the drawing. Further, the W-axis direction in the drawing may be a “width direction.”

The term “about,” as used herein, means approximately. In general, the term “about” is used herein to modify a numerical value above and below the stated value by a variance of 10%. In one aspect, the term “about” means plus or minus 20% of the numerical value of the number with which it is being used.

Hereinafter, various embodiments and modifications will be described in detail with reference to the drawings.

### Soft Magnetic Alloy Material

The soft magnetic alloy material according to some embodiments may include nanocrystals and amorphous phase, and includes Fe (iron), Co(cobalt), and P (phosphorus).

A soft magnetic alloy material according to some embodiments may be represented by Composition Formula 1.

FeₐCo_{b}P_{c}M_{d} [Composition Formula 1]

In Composition Formula 1, a, b, c, and d represent an atomic percentage content (at %) of corresponding elements, respectively, and may be 0<a≤90, 0<b≤20, 0<c≤10, 0<d≤20, and a+b+c+d=100.

M may include at least one selected from the group consisting of Si, B, Cu, Cr, C, Ni, Al, Mn, Ag, Zn, Sn, As, Sb, Bi, N, O, S, and combinations thereof.

In some embodiments, M may include B, P, Cu, or a combination thereof.

In some embodiments, M may not include Nb.

In Composition Formula 1, a represents an atomic percentage content of Fe (iron) metal, and may be 70≤a≤80. If a is less than 70, a magnetic saturation value is low and high current characteristics may not be good, and if a is more than 80, it is difficult to improve amorphous properties of the amorphous soft magnetic alloy, which is an initial alloy before heat treatment.

In Composition Formula 1, b represents an atomic percentage content of Co(cobalt) metal, and may be 2≤b≤16. If the above range is satisfied, the amorphous properties of the amorphous soft magnetic alloy may be effectively improved.

In Composition Formula 1, c represents an atomic percentage content of the P (phosphorus) element, and may be 1≤c≤6.

By including element P instead of element Nb in the above content range, the soft magnetic alloy material can control sizes of nanocrystals to implement a material with excellent electromagnetic properties.

In Composition Formula 1, b and c may be 5≤b+c≤20.

In Composition Formula 1, d may be 10≤d≤15.

As a specific example, Composition Formula 1 may be at least one selected from the group consisting of Fe_{75.2}Co₈Si₂B₁₂P₂Cu_{0.8}, Fe_{75.2}Co₈Si₂B₁₁P₃Cu_{0.8}, Fe_{75.2}Co₈Si₂B₁₀P₄Cu_{0.8}, Fe_{75.2}Co₈Si₁B₁₀P₅Cu_{0.8}, and Fe_{75.2}Co₈Si₁B₁₀P₆Cu_{0.8}.

In some embodiments, the soft magnetic alloy material may satisfy Co(c)−Co(a)>0, when the average content of Co in the amorphous phase is Co(a) (at %) and the average content of Co in the nanocrystal is Co(c) (at %). In some embodiments, the soft magnetic alloy material may satisfy P(a)−P(c)>0, when the average content of P in amorphous phase is P(a) (at %) and the average content of P in nanocrystal is P(c) (at %).

In some embodiments, the soft magnetic alloy material may satisfy Co(c)−Co(a)>0 and P(a)−P(c)>0.

Co(a) means an average content (at %) of Co element based on all atoms constituting the amorphous portion of the soft magnetic alloy material. In addition, Co(c) means an average content (at %) of Co element based on all atoms constituting the nanocrystal portion of the soft magnetic alloy material.

P(a) means an average content (at %) of element P based on all atoms constituting the amorphous portion of the soft magnetic alloy material. In addition, P(c) means an average content (at %) of element P based on all atoms constituting the nanocrystal portion of the soft magnetic alloy material.

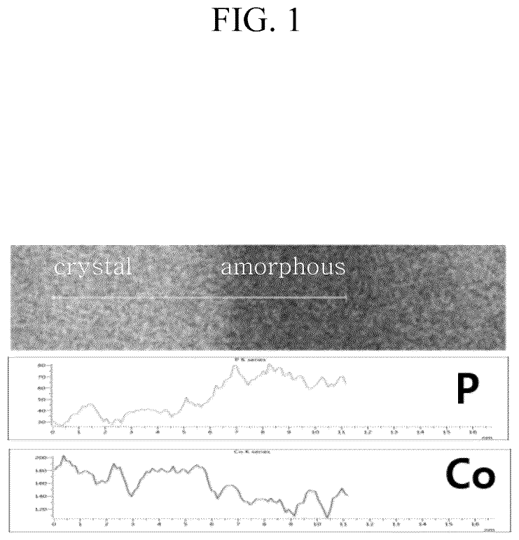

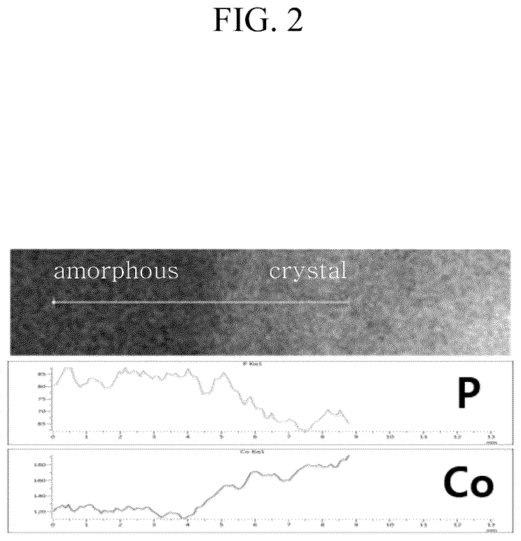

FIGS. 1 and 2 show a line profile by spot quantitative analysis through TEM analysis of a soft magnetic alloy material according to an embodiment. For reference, a boundary between the amorphous portion and the nanocrystal portion may be defined by dividing a portion having a contrast difference by a method such as binarizing a transmission electron microscope (TEM) image. In FIGS. 1 and 2, relatively bright portions correspond to nanocrystals and relatively dark portions correspond to amorphous phase.

Referring to FIGS. 1 and 2, Co(a) and Co(c), or P(a) and P(c) are measured through line analysis using an EDS (Energy Disperse X-Ray Spectrometer) installed in a transmission electron microscope (TEM).

Specifically, based on the surface of any one nanocrystal particle, in the line profile of spot quantitative analysis by 20 nm to the inside and 200 nm to the outside of the surface of nanocrystal particle, the maximum value inside the nanocrystal particle and the maximum value in the amorphous portion are compared.

In addition, in order to measure the average values, the analysis described above is repeated at least 5 points and the average value is calculated.

Referring to FIGS. 1 and 2, the soft magnetic alloy material according to some embodiments includes a Co metal and a P element having a relatively small atomic weight instead of a Nb element, so that P is more present in the amorphous phase than the nanocrystal, Co is more present in nanocrystal than in amorphous phase.

In some embodiments, the soft magnetic alloy material satisfies 0.4≤Co(c)−Co(a)≤1.5. If the Co(c)−Co(a) value is less than 0.4, it is difficult to improve the amorphous properties of the amorphous soft magnetic alloy, which is the initial alloy before heat treatment and If the Co(c)−Co(a) value exceeds 1.5, there may be a problem of non-uniform growth of nanocrystals during nanocrystal heat treatment.

In some embodiments, the soft magnetic alloy material satisfies 0.5≤P(a)−P(c)≤2.5. If the P(a)−P(c) value is less than 0.5, it is difficult to control the size of the nanocrystal, which may lead to poor electromagnetic properties. If the P(a)−P(c) value exceeds 2.5, a low nanocrystal fraction may cause problems in the implementation of Ms.

In some embodiments, the average crystal size of the nanocrystals of the soft magnetic alloy material may be less than or equal to about 20 nm. The soft magnetic alloy material may include metal Co and delay the growth of a crystal phase including Fe when it is formed, thereby significantly improving the amorphous properties of the amorphous soft magnetic alloy, which is an initial alloy before heat treatment.

For example, the average crystal size of the nanocrystals can be calculated using the Scherer equation using the full width at half maximum (FWHM) of the main peak of the XRD graph.

For example, the average size of the nanocrystals is measured by measuring the largest long axis of at least 100 nanocrystals in a scanning electron microscope (SEM) image of a cross-section of a soft magnetic alloy material to prepare a size distribution curve, and calculating D50 as the average size.

The soft magnetic alloy material described above can significantly improve the amorphous properties of the amorphous soft magnetic alloy, which is the initial alloy before heat treatment, by delaying the growth of the crystal phase when the crystal phase including Fe is formed by including metal Co.

In addition, the soft magnetic alloy material may not include Nb element, but instead may include P element having a relatively smaller atomic weight than Nb element, and after heat treatment, P element may be more present in amorphous phase than nanocrystal. Accordingly, the P element can improve electromagnetic properties such as magnetic permeability and core loss by controlling the size of the nanocrystal to a certain size or less by acting as an inhibitor to prevent the growth of the nanocrystal.

### Method of Preparing Soft Magnetic Alloy Material

A method of preparing a soft magnetic alloy material according to some embodiments includes: (1) mixing raw materials; (2) melting the mixed raw materials; (3) preparing an amorphous soft magnetic alloy by rapidly cooling the molten raw materials; and (4) heat-treating the amorphous soft magnetic alloy.

Step (1) is a step of preparing, weighing, and mixing raw materials. The raw materials may be a metal or an alloy. At the time of weighing, they may be weighed so that the soft magnetic alloy material of the final target composition is obtained. For example, the raw materials may be mixed using an arc melting method, but the present disclosure is not limited thereto.

Step (2) is a step of obtaining molten metal by melting the mixed raw materials. The melting temperature is determined in consideration of the melting point of each metal, and may be, for example, greater than or equal to about 1300° C., or greater than or equal to about 1450° C.

Step (3) is a step of preparing an amorphous soft magnetic alloy by quenching the molten raw materials. For example, quenching may be performed using a water atomization method or a gas atomization method.

The amorphous soft magnetic alloy is obtained after weighing, mixing, melting, and quenching raw materials of the alloy. In addition, some nanocrystals may be formed in the amorphous soft magnetic alloy.

Step (4) is a step of preparing a soft magnetic alloy material including nanocrystals and amorphous material by heat-treating the amorphous soft magnetic alloy. For example, heat treatment may be performed at a temperature of about 350 to about 500° C. for about 10 to about 60 minutes.

In some embodiments, the amorphous rate calculated by Equation 1 of the amorphous soft magnetic alloy may be greater than or equal to about 95%.

Amorphous rate (%)=[Ia/(Ic+Ia)]×100 [Equation 1]

In Equation 1, Ic is a sum of scattering intensity integrals of crystalline peaks in the X-ray diffraction analysis spectrum of the amorphous soft magnetic alloy, and Ia is a sum of integral values of scattering intensities of amorphous halo in the X-ray diffraction analysis spectrum of the amorphous soft magnetic alloy.

The amorphous rate of the amorphous soft magnetic alloy may be calculated based on a graph obtained by X-ray diffraction spectroscopy. In the X-ray diffraction analysis spectrum, a relationship of 2d·sin θ=nλ is established between a wavelength λ and incident angle θ of the incident X-ray and a lattice spacing d, which is called the Bragg equation. Accordingly, when the incident angle is determined, the lattice spacing d can be obtained.

However, since a random arrangement rather than a regular atomic arrangement appears in an amorphous material, a plurality of X-ray diffraction does not appear at a specific wavelength, and a broad halo pattern appears in a region with a diffraction angle of 15° to 35°. If there is no peak appearing at a specific angle within the diffraction angle range of 10° to 60° and a diffuse halo pattern appears, it can be determined that the amorphous material has an amorphous rate of 100%. However, the surface of the amorphous soft magnetic alloy exposed to X-rays must not contain contaminants other than organic material. Reliability is high as long as the result is measured under the condition that there are no factors affecting the diffraction pattern.

If crystals exist in the amorphous soft magnetic alloy, one or more crystalline peaks exist in the measured diffraction angle range. The presence of a peak means that the peak can be recognized with the naked eye at least on the X-ray diffraction diagram with the maximum intensity in the range of the diffraction angle of 2θ=5° or more and 50° or less in the XRD pattern graph as the entirety of the vertical axis, or that the waveform processing unit can clearly distinguish it from background noise and recognize it as a peak.

At this time, if the amorphous rate is low, the halo region is reduced, and the halo region does not exist in a material with an amorphous rate of 0%. When crystal and amorphous phase are mixed, the amorphous rate can be calculated by calculating the relative ratio of the area of the crystalline peak and the area of the halo region in the graph consisting of intensity and diffraction angle range.

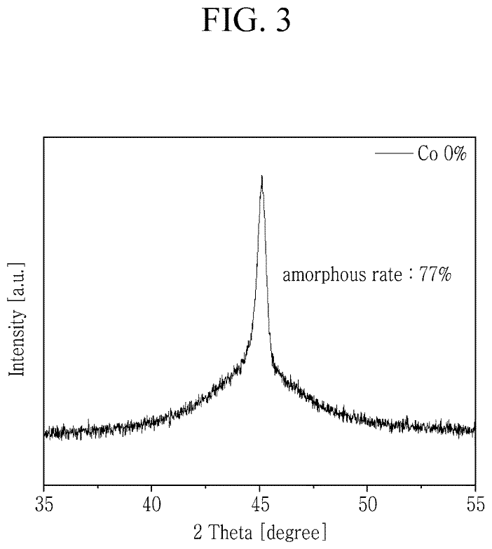

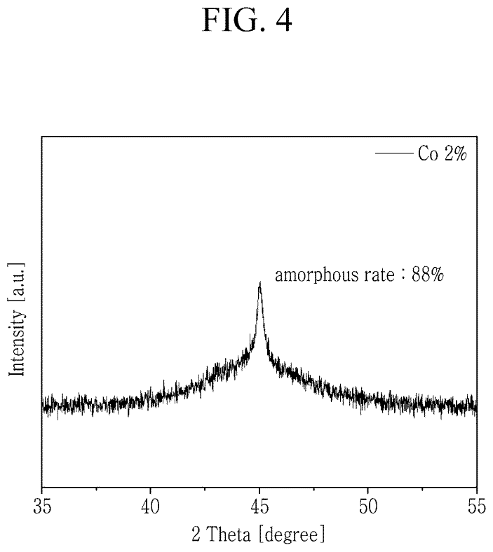

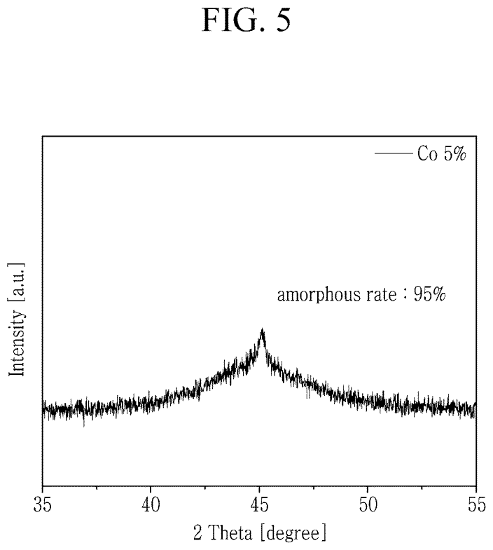

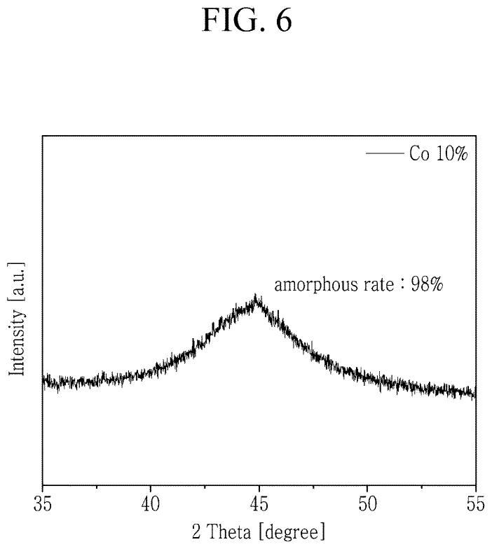

FIGS. 3 to 6 are graphs showing amorphous rates of the amorphous soft magnetic alloys according to the content (at %) of Co metal. Referring to FIGS. 3 to 6, when the above-described metal Co is included in the soft magnetic alloy material in a specific numerical range, the amorphous rate of the amorphous soft magnetic alloy becomes greater than or equal to about 95%, so that high amorphousness can be implemented. The amorphous soft magnetic alloy having high amorphous properties has an advantage of having little magnetic loss when used in a magnetic product such as an inductor after heat treatment.

### Inductor

Hereinafter, an example of the inductor 100 including a magnetic material including the soft magnetic alloy material described above will be described. Types of the inductor may include a thin film-type inductor, a multilayer-type inductor, a wound-type inductor, or a rolled-type inductor, and the thin film-type inductor will be described first.

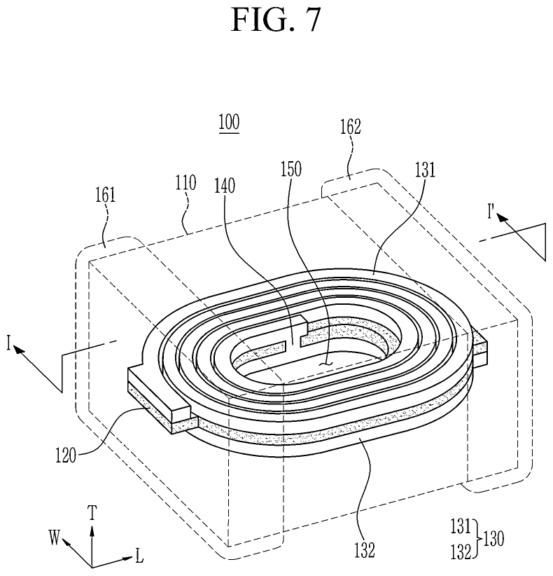

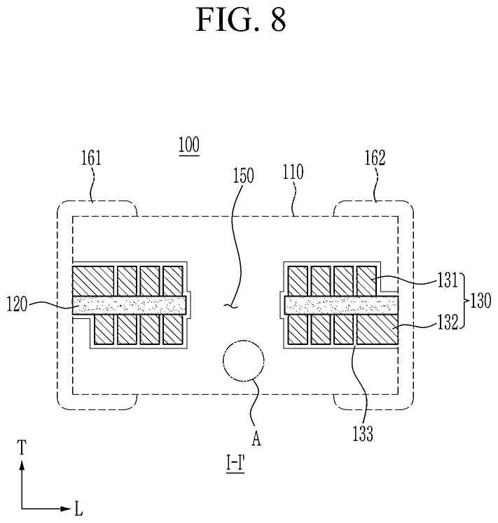

FIG. 7 is a schematic perspective view of a thin film-type inductor according to an embodiment, and FIG. 8 is a schematic view of an incision surface in an I-I′ direction of FIG. 7, and schematically showing a cross-sectional view of the inductor shown in FIG. 7. The thin film-type inductor 100 according to an embodiment includes a body 110 including a magnetic material including a soft magnetic alloy material; a coil 130 in the body; and external electrodes 161 and 162 on the outer surface of the body 110.

The body 110 forms the appearance of the thin film-type inductor 100.

The body 110 may have a hexahedral shape including upper and lower surfaces facing each other in the stacking direction of coils, side surfaces facing in a side direction and front faces facing each other in the width direction, and when the printed circuit board is mounted, the lower surface (other surface) of the body may be a mounting surface. A corner where each surface meets may be rounded by grinding or the like.

The body 110 may be formed by forming the coil 130, stacking sheets including magnetic materials on top and bottom of the coil 130, and then compressing and curing the sheet.

The body 110 includes a magnetic material, and the magnetic material includes a soft magnetic alloy material according to an embodiment.

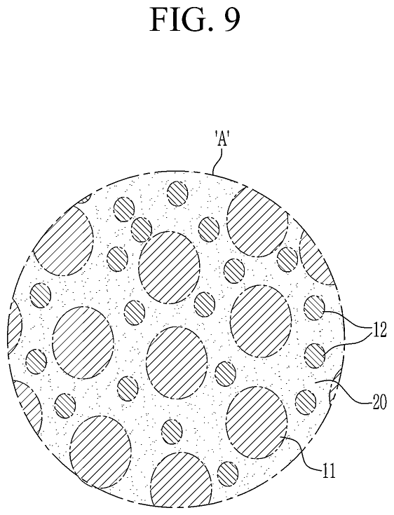

FIG. 9 is an enlarged view of region A of FIG. 8.

Referring to FIG. 9, the magnetic material may include a resin 20 and magnetic particles including coarse powder magnetic particles 11 or fine powder magnetic particles 12. For example, the coarse powder magnetic particles 11 and the fine powder magnetic particles 12 may be mixed and dispersed in a predetermined ratio using the resin 20 as a matrix.

The coarse powder magnetic particles 11 may be particles having an average particle diameter of about 10 μm to about 30 μm, and the fine powder magnetic particles 12 may be particles having an average particle diameter of about 1 μm to about 10 μm.

A diameter of the magnetic particles present in the body 110 may be measured from a cross section of the body 110. Specifically, with respect to the cross section in the L-T direction passing through the center of the body 110, a plurality of regions (e.g., 10 regions) at equal intervals in the T-axis direction are photographed with a scanning electron microscope, and then the diameter of the magnetic particle can be obtained using an image analysis program. In this case, since the outer region of the body 110 may be deformed or destroyed by a compression process or the like, the diameter of the magnetic particle may be measured except for this region. For example, a region corresponding to a length within about 5% or about 10% of the surface of the body 110 may be excluded.

As the magnetic particles, those used in the industry may be used without limitation. For example, ferrite or a metal-based soft magnetic material may be used as the magnetic particles.

The ferrite may include known ferrites such as Mn—Zn-based ferrite, Ni—Zn-based ferrite, Ni—Zn—Cu-based ferrite, Mn—Mg-based ferrite, Ba-based ferrite, or Li-based ferrite.

The metal-based soft magnetic material may be an alloy containing at least one selected from the group consisting of Fe, Si, Cr, Al, and Ni, and may include, for example, Fe—Si—B—Cr-based amorphous metal particles, but is not limited thereto.

In some embodiments, the magnetic particles may include a soft magnetic alloy material, and for example, the coarse powder magnetic particles may be the soft magnetic alloy material.

The resin may be an insulating resin, and may include an epoxy resin, a polyimide resin, a liquid crystal polymer, or a combination thereof, but is not limited thereto.

The soft magnetic alloy material may include nanocrystals and amorphous phase, and includes Fe (iron), Co(cobalt), and P (phosphorus).

The soft magnetic alloy material may be represented by Composition Formula 1:

FeₐCo_{b}P_{c}M_{d} [Composition Formula 1]
wherein in Composition Formula 1, a, b, c, and d represent an atomic percentage content (at %) of corresponding elements, respectively, 0<a≤90, 0<b≤20, 0<c≤10, 0<d≤20, a+b+c+d=100, and
M includes at least one selected from the group consisting of Si, B, Cu, Cr, C, Ni, Al, Mn, Ag, Zn, Sn, As, Sb, Bi, N, O, S, and combinations thereof.

In some embodiments, M may include B, P, Cu, or a combination thereof, and M may not include Nb.

In Composition Formula 1, a represents an atomic percentage content of Fe (iron) metal, and may be 70≤a≤80.

In Composition Formula 1, b represents an atomic percentage content of Co(cobalt) metal, and may be 2≤b≤16.

In Composition Formula 1, c represents an atomic percentage content of the P (phosphorus) element, and may be 1≤c≤6.

By including element P instead of element Nb in the above content range, the soft magnetic alloy material may control the size of nanocrystals to implement an inductor having excellent electromagnetic properties.

In the soft magnetic alloy material included in the inductor, when an average content of Co in the amorphous phase is Co(a) (at %) and an average content of Co in the nanocrystal is Co(c) (at %), Co(c)−Co(a)>0 or when an average P content in the amorphous phase is P(a) (at %) and an average P content in the nanocrystal is P(c) (at %), P(a)−P(c)>0. In some embodiments, Co(c)−Co(a)>0 and P(a)−P(c)>0.

A method of measuring Co(a), Co(c), P(a), and P(c) in the inductor 100 is as follows.

In a cross-sectional sample cut in the L-axis direction and the T-axis direction from the center of the W-axis direction of the inductor body 110 (hereinafter referred to as “cross-sectional sample”), the soft magnetic alloy material dispersed in the resin is subjected to line analysis using an Energy Disperse X-Ray Spectrometer (EDS) installed in a Transmission Electron Microscope (TEM).

The cross-sectional sample of the inductor body 110 may be, for example, prepared by adding the inductor 100 in an epoxy mixture and curing, and then polishing the L-axis and T-axis sides of the inductor body 110 to the ½ point in the W-axis direction, and fixing and holding in a vacuum atmosphere chamber.

Specifically, based on the surface of any one nanocrystal particle included in the soft magnetic alloy material, in the line profile of spot quantitative analysis by 20 nm to the inside and 200 nm to the outside of the surface of nanocrystal particle, the maximum value inside the nanocrystal particle and the maximum value in the amorphous portion are compared. In addition, in order to measure the average, the analysis described above is repeated at least 5 points and the average value is calculated.

An average crystal size of the nanocrystals included in the soft magnetic alloy material may be less than or equal to about 20.

For example, the average crystal size of the nanocrystals can be calculated using the Scherer equation using the full width at half maximum (FWHM) of the main peak of the XRD graph.

Specifically, the average crystal size of the nanocrystals may be calculated by using the full width at half maximum after obtaining an XRD graph of the soft magnetic alloy material in the cross-sectional sample of the inductor body 110. An XRD graph of the soft magnetic alloy material can be obtained through a sample obtained by pulverizing and sieving a cross-sectional sample of the body to a size of greater than or equal to about 20 μm.

For example, the average crystal size of the nanocrystals can also be measured in a scanning electron microscope (SEM) or transmission electron microscope (TEM) image of a cross-sectional sample of the body, in a soft magnetic alloy material corresponding to coarse powder magnetic particles having a particle diameter of about 10 μm to about 30 μm. Specifically, in the image of the cross-sectional sample, with the central point in the L-axis direction as the reference, it can be derived by measuring the size of nanocrystals generated inside the coarse powder magnetic particles observed in a plurality of regions (e.g., 10 regions) at predetermined intervals in the T-axis direction, and calculating the average value. Intervals between the plurality of regions may be adjusted according to the scale of a scanning electron microscope (SEM) or transmission electron microscope (TEM) image, and may be equally spaced. At this time, all of the plural regions must be located within the body, and if all 10 points are not located within the body, the position of the reference point may be changed or the interval between the 10 points may be adjusted.

Since the soft magnetic alloy material is the same as that described above, the rest of the description is omitted.

In some embodiments, an insulating film (not shown) may be additionally disposed on the surface of the soft magnetic alloy material to impart insulating properties and secure inductance.

The insulating film may be disposed in one or more layers, and may be disposed in a maximum of three layers. For example, the insulating film may be an organic film including at least one selected from the group consisting of an epoxy resin, a polyimide resin, a liquid crystal polymer, and combinations thereof. The insulating film may include at least one selected from the group consisting of silicon oxide (SiO) or silica (SiO₂), an inorganic film including alumina (Al₂O₃), and a metal oxide film such as FeO (iron oxide) or CrO (chromium oxide). When the insulating film is the metal oxide film, the metal oxide film may include a metal element included in the soft magnetic alloy material, but is not limited thereto.

A thickness of the insulating film may be about 1 to about 20% of a particle diameter of the soft magnetic alloy material.

If the thickness of the insulating film exceeds about 20% of the particle diameter of the soft magnetic alloy material, magnetic permeability and magnetic susceptibility may be reduced, and thus it is desirable to make the thickness as thin as possible.

The coil 130 is disposed inside the body 110 and plays a role of expressing characteristics of the inductor. For example, when the inductor 100 is used as a power inductor, the coil stores an electric field as a magnetic field to maintain an output voltage, thereby stabilizing a power supply of an electronic device. The coil may be any type among a wound-type formed in a winding method, a thin film-type formed in a thin film method, or a multilayer-type formed in a stacking method, but hereinafter, the thin film-type coil may be described as an example.

The coil 130 may include an upper coil 131 and a lower coil 132 respectively disposed on the upper and lower surfaces of a support member 120. The upper coil 131 and the lower coil 132 may be coil layers disposed facing each other with respect to the support member 120.

The upper coil 131 and the lower coil 132 may be formed as plating layers on the support member 120 in a plating process or a photolithography method.

The coil 130 may include a material with excellent electrical conductivity, for example, at least one type of metal selected from gold (Au), silver (Ag), platinum (Pt), copper (Cu), nickel (Ni), palladium (Pd), aluminum (Al), titanium (Ti), and the like or an alloy thereof, but any conventional conductive material may be adopted without particular limitations.

The support member 120 may include any material capable of supporting the upper coil 131 and the lower coil 132 without particular limitations, for example, a copper clad laminate (CCL), a polypropylene glycol (PPG) substrate, a ferrite substrate, a metal-based soft magnetic substrate, or the like. In addition, an insulation substrate made of an insulation resin may be used. The insulation resin may include a thermosetting resin such as an epoxy resin, a thermoplastic resin such as polyimide, or a resin in which a reinforcing material such as a glass fiber or an inorganic filler is impregnated, such as prepreg, ABF (ajinomoto build-up film), FR-4, a BT (bismaleimide triazine) resin, a PID (photo imageable dielectric) resin, etc. In terms of maintaining rigidity, an insulation substrate including the glass fiber and the epoxy resin may be used but is not limited thereto.

The upper and lower surfaces of the support member 120 may be penetrated to form a hole, and the hole may be filled with a magnetic material to form a core portion 150. The core portion filled with the magnetic material may improve inductance.

The upper coil 131 and the lower coil 132 stacked on both surfaces of the support member are electrically connected through a via 140 penetrating the support member 120.

The via 140 may be formed by using a mechanical drill or a laser drill to form a through-hole and filling the through-hole with a conductive material through plating.

The via 140 may not be limited in terms of a shape or a material, as long as the upper coil 131 and the lower coil 132 respectively disposed on both upper and lower surfaces of the support member 120 are electrically connected. Herein, the upper and lower surfaces are determined, based on a stacking direction of coil patterns in the drawing.

The via 140 may include a conductive material including at least one selected from the group consisting of copper (Cu), aluminum (Al), silver (Ag), tin (Sn), gold (Au), nickel (Ni), lead (Pd), and an alloy thereof, and the like.

The upper and lower coils 131 and 132 may be covered with an insulating layer 133 not to directly connect the magnetic material included in the body 110.

The insulating layer 133 may serve to protect the upper and lower coils 131 and 132.

The insulating layer 133 may be formed of any material including an insulating material, for example, an insulating material used for a conventional insulation coating, for example, an epoxy resin, a polyimide resin, a liquid crystal crystalline polymer resin, and the like, wherein a known photo imageable dielectric (PID) resin may be used, but is not limited thereto.

The insulating layer 133 may be formed in a vapor deposition method and the like but not limited thereto and formed to be laminated on both surfaces of the support member.

The inductor 100 according to an embodiment is electrically connected to the upper and lower coils 131 and 132 and includes the external electrodes 161 and 162 on the outer surface of the body 110.

The external electrodes 161 and 162 are electrically connected to each draw-out terminal of the upper and lower coils 131 and 132 exposed on both sides of the body 110.

The external electrodes 161 and 162, when the inductor 100 is mounted on an electronic device, serve to electrically connect the coil 130 inside the inductor to the electronic device.

The external electrodes 161 and 162 may include a plurality of electrode layers.

The plurality of electrode layers may be formed by using a conductive paste including a conductive metal or a conductive resin.

The conductive resin layer may include a conductive metal for ensuring electrical conductivity and a resin for impact absorption. The resin is not particularly limited as long as it has bondability and impact absorption and can be mixed with conductive metal powder to form a paste. For example, it may include a phenol resin, an acrylic resin, a silicone resin, an epoxy resin, or a polyimide resin.

The conductive metal may include, for example, at least one selected from the group consisting of copper (Cu), tin (Sn), nickel (Ni), silver (Ag), palladium (Pd), gold (Au), platinum (Pt), tungsten (W), titanium (Ti), an alloy thereof, and combinations thereof.

The external electrodes 161 and 162 may include a plurality of plating layers formed by plating a conductive metal.

For example, the plating layer may include at least one selected from the group consisting of nickel (Ni), copper (Cu), tin (Sn), and combinations thereof. For example, a nickel (Ni) layer and a tin (Sn) layer may be sequentially formed, for example, a copper (Cu) layer, a nickel (Ni) layer, and a tin (Sn) layer may be sequentially formed.

Hereinafter, a wound-type inductor 200 and a multilayer-type inductor 300 will be described in detail. Hereinafter, the wound-type inductor 200 and the multilayer-type inductor 300 will be described only with respect to configuration differences from that of the thin film-type inductor 100. The descriptions of the thin film-type inductor 100 may be applied to the rest of the configuration thereof.

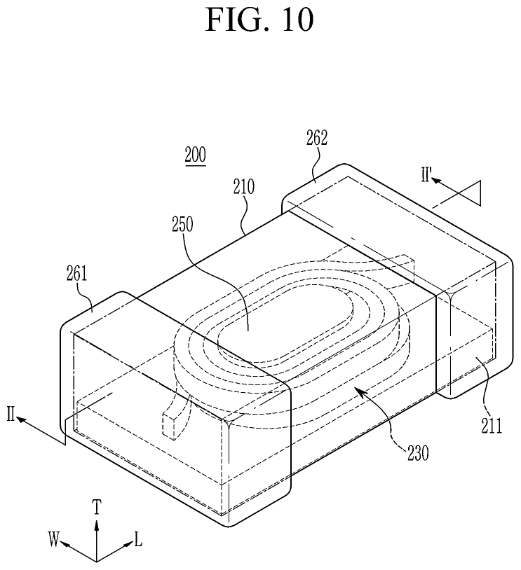

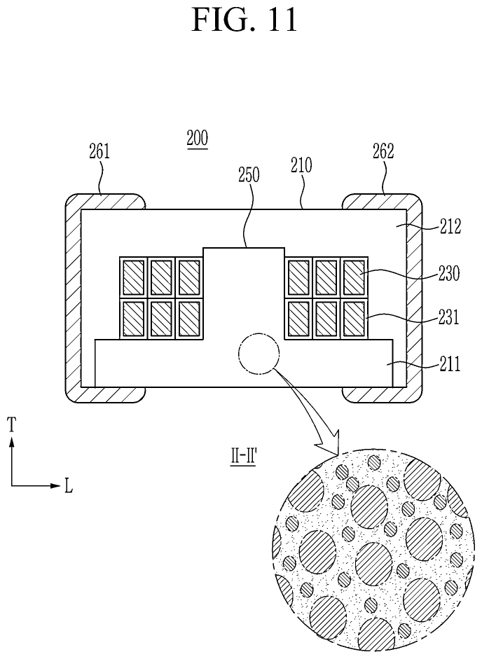

FIG. 10 schematically shows a transmission perspective view of the wound-type inductor according to another embodiment, and FIG. 11 schematically shows a cross-section of the inductor of FIG. 10 cut in a II-II′ direction of FIG. 10.

The wound-type inductor 200 according to some embodiments includes a body 210 including a magnetic material including a soft magnetic alloy material; a coil 230 inside the body; and external electrodes 261 and 262 on the outer surface of the body 210.

In some embodiments, the body 210 includes a mold portion 211; a cover portion 212 disposed on one surface of the mold portion 211; and a core 250 protruded from one surface of the mold portion 212, the coil 230 is disposed between one surface of the mold portion 211 and the cover portion 212, and the core 250 penetrates the coil 230.

The body 210 of the wound-type inductor 200 includes the mold portion 211 and the cover portion 212 disposed on one surface of the mold portion 211 and further include the core 250 disposed to be protruded from one surface of the mold portion 211. Herein, the coil 230 may be disposed one surface of the mold portion 211 to wrap the core 250.

The body 210 includes a magnetic material, and the magnetic material includes a soft magnetic alloy material according to some embodiments. In other words, at least one of the mold portion 211, the cover portion 212, and the core 250 may include the magnetic material including the soft magnetic alloy material. For example, the mold portion 211 may be formed by filling the magnetic material in a mold. As another example, the mold portion 211 may be formed by filling a composite material including the magnetic material and a resin in the mold. A process of applying a high temperature and a high pressure to the magnetic material or the composite material in the mold may be additionally performed but is not limited thereto. The mold portion 211 and the core 250 may be integrally formed by the aforementioned mold without a boundary therebetween. The cover portion 212 may be formed by disposing a magnetic composite sheet in which the magnetic material is dispersed in the resin on the mold portion 211 and the coil 230 and then, heating and pressing it.

In the wound-type inductor 200, a draw-out portion (not shown) penetrates the mold portion 211 to be connected to the external electrodes 261 and 262.

The descriptions of the thin film-type inductor 100 according to some embodiments may be equally applied to the magnetic material and the soft magnetic alloy material in the body 210.

In the wound-type inductor 200, the surface of the coil 230 may be covered with an insulating layer 231, and the insulating layer 231 serves to insulate the magnetic material of the body 210 from the coil 230. The same descriptions of the insulating layer 133 may be applied to those of the insulating layer 231.

The wound-type inductor 200 may be different from the thin film-type inductor 100, in terms of the configuration of the coil 230 and the presence or absence of the support member.

The coil 230 is a wound-type and includes no support member. The coil 230 may be a wound coil formed by winding a metal wire such as a copper wire (Cu-wire) including a metal line and the insulating layer 231 covering the surface of the metal line and the like. The metal wire may be a flat line but is not limited thereto.

In FIG. 10, the coil 230 is shown as an alpha (α)-shaped wound wire but only exemplary and may be an edge-wise wound wire.

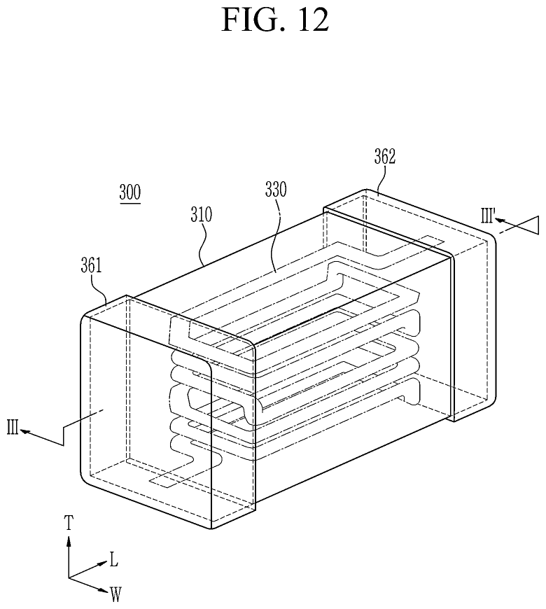

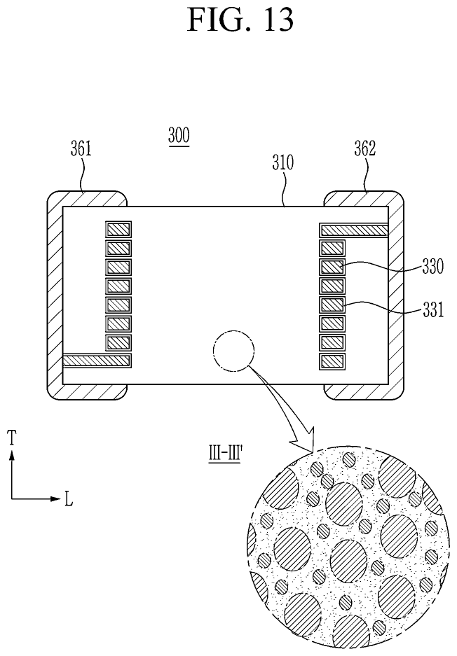

FIG. 12 schematically shows a perspective view of a multilayer-type inductor according to another embodiment and FIG. 13 schematically shows a cross-sectional view of the inductor shown in FIG. 12 in a direction II-II′ of FIG. 12.

A multilayer-type inductor 300 according to some embodiments includes a body 310 including a magnetic material including a soft magnetic alloy material; a coil 330 in the body; and external electrodes 361 and 362 on an outer surface of the body 310, wherein the body 310 includes a plurality of magnetic sheets including the magnetic material.

The descriptions of the magnetic material and the soft magnetic alloy material in the body 310 may be equally applied to the descriptions of the thin film-type inductor 100 according to an embodiment.

For example, the body 310 is obtained by stacking a plurality of magnetic sheets including the magnetic material in a thickness direction and firing them, wherein the shape and dimensions of the body 310 and the number of stacked magnetic sheets are not limited to those shown in an embodiment.

On one surface of the plurality of magnetic sheets, conductor patterns for forming the coil 330 is formed, and a conductive via may be formed to electrically connect the upper and lower conductive patterns in a thickness direction of the magnetic sheets.

Accordingly, one ends of the conductor patterns formed on each magnetic sheet are electrically connected to each other through the conductive via formed on the adjacent magnetic sheet, forming the coil 330.

The surface of the coil 330 may be covered with an insulating layer 331, and the insulating layer 331 may conduct a function of insulating the magnetic material of the body 310 from the coil 330. The insulating layer 331 may be applied in the same manner as the descriptions of the insulating layer 133 described above.

Both ends of the coil 330 may be drawn out through the body 310 to contact a pair of the external electrodes 361 and 362 formed in the body 310 and electrically connected thereto, respectively.

In particular, both ends of the coil 330 may be drawn out through both ends of the body 310, and the pair of external electrodes 361 and 362 may be formed at both ends of the body 310 from which the coil 330 is drawn out.

The conductor pattern may be formed by thick-film printing a conductive paste for forming a conductor pattern on a green sheet for forming the magnetic sheet and then, coating, deposition, and sputtering the conductive paste but is not limited thereto.

The conductive via may be formed by forming a through-hole in each sheet in the thickness direction and then, filling the through-hole with a conductive paste and the like but is not limited thereto.

In addition, a conductive metal included in the conductive paste for forming a conductor pattern may be at least one selected from the group consisting of silver (Ag), palladium (Pd), platinum (Pt), nickel (Ni), and copper (Cu) or an alloy thereof, but the present disclosure is not limited thereto.

The soft magnetic alloy material, when included in the body of the aforementioned thin film-type, wound-type, or multilayer-type inductor, may maintain high magnetic saturation characteristics as well as improve electromagnetic properties due to its excellent characteristics.

In addition to the inductor described above, the soft magnetic alloy material may be used for a magnetic product such as a transformer, a motor, or a stator of the motor, and the like.

Hereinafter, specific examples of the embodiments are presented. However, the examples described below are only intended to specifically illustrate or explain the present embodiment, and the scope of the present disclosure should not be limited thereto.

### (Preparation Example: Preparation of Amorphous Soft Magnetic Alloy)

### Preparation Example 1

In order to obtain an amorphous soft magnetic alloy represented by composition formula Fe_{75.2}Co₈Si₂B₁₂P₂Cu_{0.8}, a master alloy was prepared by weighing and mixing Fe, Co, Si, B, P, and Cu raw materials and using an arc melting method. The prepared master alloy was molten and then, rapidly cooled in a rapid cooling facility to produce a ribbon-shaped amorphous soft magnetic alloy with a thickness of 20 μm.

### Preparation Examples 2 to 5, and Comparative Preparation Examples 1 to 10

Each amorphous soft magnetic alloy was prepared in the same manner as in Preparation Example 1 except that the composition formula was represented as shown in Table 2.

### (Example: Preparation of Soft Magnetic Alloy Material)

The amorphous soft magnetic alloys according to Preparation Examples 1 to 5 and Comparative Preparation Examples 1 to 10 were heat-treated (400° C., 40 min), preparing each soft magnetic alloy material according to Examples 1 to 5 and Comparative Examples 1 to 10. The soft magnetic alloy materials of the examples were regarded to have the same composition formula of the amorphous soft magnetic alloy of the preparation examples.

### (Experimental Example 1: Before Heat Treatment-Amorphous Rate Analysis)

The amorphous soft magnetic alloys of Preparation Examples 1 to 5 and Comparative Preparation Examples 1 to 10 were calculated with respect to an amorphous rate (%) according to according to [Equation 1] described above through a ratio of amorphous and crystalline areas obtained after data fitting from an XRD analysis, and the results are shown in Table 3.

Referring to Table 3, Preparation Examples 1 to 5 exhibited an amorphous rate of 95% or higher, which confirms improved amorphous characteristics.

On the contrary, Comparative Preparation Examples 1 to 10 including no Co metal exhibited an amorphous rate of less than 95%, which confirms gradually deteriorated amorphous characteristics.

### (Experimental Example 2: After Heat Treatment—Analysis of Difference in Co and P Content Between Amorphous Phase and Crystalline Phase)

A spot quantitative analysis of each of the soft magnetic alloy materials of Examples 1 to 5 through TEM analysis was performed at 6 points, from which an average content is calculated. Herein, each Co content (Co(a), Co(c)) (unit: at %) in the amorphous phase and the crystalline phase is shown in Table 1. In addition, each P content (P(a), P(c)) (unit: at %) in the amorphous phase and the crystalline phase is shown in Table 2.

Referring to Table 1, the average Co atom content (Co(c)) in the nanocrystals was higher than the average P atom content (P(a)) in the amorphous. Accordingly, when a Co metal was included, growth of a crystal including Fe was delayed.

Referring to Table 2, the average P atom content (P(a)) in the amorphous was higher than the average P atom content (P(c)) in the nanocrystals. Accordingly, P elements having a relatively smaller atomic weight than Nb 5 elements remained in the amorphous and acted to suppress growth of the nanocrystals in the soft magnetic alloy materials.

TABLE 1

| | | Co(a) | | | | | | | Co(c) | | | | | | |
|---|---|---|---|---|---|---|---|---|---|---|---|---|---|---|---|
| | Composition Formula | 1 | 2 | 3 | 4 | 5 | 6 | avg. | 1 | 2 | 3 | 4 | 5 | 6 | avg. |
| Example | Fe_{75.2}Co₈Si₂B₁₂P₂Cu_{0.8} | 3.54 | 3.85 | 3.95 | 3.75 | 3.71 | 3.5 | 3.72 | 4.53 | 4.32 | 4.51 | 4.44 | 4.78 | 4.17 | 4.46 |
| 1 | | | | | | | | | | | | | | | |
| Example | Fe_{75.2}Co₈Si₂B₁₁P₃Cu_{0.8} | 3.33 | 3.54 | 3.47 | 3.98 | 3.97 | 3.91 | 3.7 | 4.66 | 4.14 | 4.12 | 4.54 | 4.44 | 4.87 | 4.46 |
| 2 | | | | | | | | | | | | | | | |
| Example | Fe_{75.2}Co₈Si₂B₁₀P₄Cu_{0.8} | 3.14 | 3.17 | 3.85 | 3.47 | 3.64 | 3.78 | 3.99 | 4.11 | 4.21 | 4.54 | 4.48 | 4.41 | 4.82 | 4.43 |
| 3 | | | | | | | | | | | | | | | |
| Example | Fe_{75.2}Co₈Si₁B₁₀P₅Cu_{0.8} | 3.54 | 3.04 | 3.45 | 3.11 | 3.51 | 3.87 | 3.42 | 4.21 | 4.44 | 4.54 | 4.84 | 4.94 | 4.81 | 4.63 |
| 4 | | | | | | | | | | | | | | | |
| Example | Fe_{75.2}Co₈Si₁B₁₀P₆Cu_{0.8} | 3.24 | 3.42 | 3.33 | 3.68 | 3.39 | 3.28 | 3.39 | 4.23 | 4.28 | 4.18 | 4.09 | 4.19 | 4.39 | 4.23 |
| 5 | | | | | | | | | | | | | | | |

TABLE 2

| | | P(a) | | | | | | | P(c) | | | | | | |
|---|---|---|---|---|---|---|---|---|---|---|---|---|---|---|---|
| | Composition Formula | 1 | 2 | 3 | 4 | 5 | 6 | avg. | 1 | 2 | 3 | 4 | 5 | 6 | avg. |
| Example | Fe_{75.2}Co₈Si₂B₁₂P₂Cu_{0.8} | 1.15 | 1.25 | 1.34 | 1.28 | 1.19 | 1.41 | 1.27 | 0.56 | 10.66 | 0.67 | 0.71 | 0.75 | 0.64 | 0.67 |
| 1 | | | | | | | | | | | | | | | |
| Example | Fe_{75.2}Co₈Si₂B₁₁P₃Cu_{0.8} | 1.98 | 2.04 | 2.04 | 1.88 | 1.94 | 2.21 | 2.02 | 1.11 | 1.12 | 1.05 | 0.99 | 1.87 | 1.15 | 1.22 |
| 2 | | | | | | | | | | | | | | | |
| Example | Fe_{75.2}Co₈Si₂B₁₀P₄Cu_{0.8} | 2.9 | 3.01 | 3.21 | 2.98 | 2.51 | 2.88 | 2.92 | 1.35 | 1.65 | 1.55 | 1.11 | 1.21 | 1.81 | 1.45 |
| 3 | | | | | | | | | | | | | | | |
| Example | Fe_{75.2}Co₈Si₁B₁₀P₅Cu_{0.8} | 3.89 | 4.11 | 3.54 | 3.54 | 3.65 | 3.88 | 3.75 | 1.45 | 1.44 | 1.38 | 1.78 | 1.34 | 1.55 | 1.49 |
| 4 | | | | | | | | | | | | | | | |
| Example | Fe_{75.2}Co₈Si₁B₁₀P₆Cu_{0.8} | 4.11 | 4.39 | 4.01 | 4.08 | 3.99 | 3.64 | 4.09 | 1.56 | 1.46 | 1.64 | 1.66 | 1.67 | 1.71 | 1.62 |
| 5 | | | | | | | | | | | | | | | |

### (Experimental Example 3: After Heat Treatment-Crystal Size Analysis)

Each soft magnetic alloy material of Examples 1 to 5 and Comparative Examples 1 to 10 was measured with respect to an average nanocrystal size by using a full width at half maximum (FWHM) of a main peak of the XRD graph and Scherer equation expressed by Equation 2. The results are shown in Table 3.

$$D = \frac{0.9 λ}{β cos θ} \qquad [ Equation 2 ]$$

In Equation 2, D is an average crystal size, λ is a wavelength of an XRD target, β is a full width at half maximum (FWHM), and θ is a half of XRD graph peak 2θ.

Referring to Table 3, the nanocrystals of Examples 1 to 5 had an average crystal size of less than or equal to about 20.

On the contrary, the nanocrystals of Comparative Examples 6 to 10 including no P element had an average crystal size of greater than 20 nm.

### (Experimental Example 4: Evaluation of Electromagnetic Properties)

Each soft magnetic alloy material of Examples 1 to 5 and Comparative Examples 1 to 10 was measured with respect to magnetic permeability at a frequency of 1 kHz and a core loss under 0.2 T, 100 kHz magnetic field, and the results are shown in Table 3.

Referring to Table 3, Examples 1 to 5 exhibited magnetic permeability of greater than or equal to 5300 and a core loss of less than or equal to 1700 mW/cc, which confirm excellent electromagnetic properties.

On the contrary, Comparative Examples 6 to 10 including no P element exhibited magnetic permeability of less than 5300 and a core loss of greater than 1700 mW/cc, which confirm significantly deteriorated electromagnetic properties.

TABLE 3

| | | Heat treatment | | | | |
|---|---|---|---|---|---|---|
| | | Temperature | | Core | Amorphous | Nanocrystal |
| | | (° C.)/hour | Magnetic | loss | rate | Size |
| | Composition Formula | (min) | permeability | (mW/cc) | (%) | (nm) |
| Comparative | Fe_{82.2}Si₂B₁₃Nb₂Cu_{0.8} | 475/60 | 5865 | 1546 | 85 | 19.9 |
| Example 1 | | | | | | |
| Comparative | Fe_{82.2}Si₃B₁₂Nb₂Cu_{0.8} | 475/60 | 5465 | 1584 | 82 | 19.5 |
| Example 2 | | | | | | |
| Comparative | Fe_{81.2}Si₃B₁₂Nb₃Cu_{0.8} | 475/60 | 5324 | 1485 | 88 | 19.7 |
| Example 3 | | | | | | |
| Comparative | Fe_{83.2}Si₂B₁₁Nb₃Cu_{0.8} | 475/60 | 5124 | 1534 | 77 | 20.7 |
| Example 4 | | | | | | |
| Comparative | Fe_{83.2}Si₁B₁₂Nb₃Cu_{0.8} | 475/60 | 5177 | 1465 | 81 | 21.9 |
| Example 5 | | | | | | |
| Comparative | Fe_{81.2}Co₂Si₂B₁₄Cu_{0.8} | 450/30 | 4899 | 2642 | 88 | 24.5 |
| Example 6 | | | | | | |
| Comparative | Fe_{79.2}Co₄Si₂B₁₄Cu_{0.8} | 450/30 | 4695 | 2574 | 95 | 25.6 |
| Example 7 | | | | | | |
| Comparative | Fe_{75.2}Co₈Si₂B₁₄Cu_{0.8} | 450/30 | 4562 | 2546 | 98 | 24.7 |
| Example 8 | | | | | | |
| Comparative | Fe_{67.2}Co₁₆Si₂B₁₄Cu_{0.8} | 450/30 | 4511 | 2645 | 98 | 23.4 |
| Example 9 | | | | | | |
| Comparative | Fe_{51.2}Co₃₂Si₂B₁₄Cu_{0.8} | 450/30 | 4465 | 2485 | 55 | 23.9 |
| Example 10 | | | | | | |
| Example 1 | Fe_{75.2}Co₈Si₂B₁₂P₂Cu_{0.8} | 475/30 | 5472 | 1555 | 95 | 19.5 |
| Example 2 | Fe_{75.2}Co₈Si₂B₁₁P₃Cu_{0.8} | 475/30 | 5345 | 1647 | 98 | 19.2 |
| Example 3 | Fe_{75.2}Co₈Si₂B₁₀P₄Cu_{0.8} | 475/30 | 5384 | 1457 | 98 | 19.8 |
| Example 4 | Fe_{75.2}Co₈Si₁B₁₀P₅Cu_{0.8} | 475/30 | 5485 | 1547 | 98 | 19.4 |
| Example 5 | Fe_{75.2}Co₈Si₁B₁₀P₆Cu_{0.8} | 475/30 | 5401 | 1508 | 97 | 19.5 |

In Table 3, the amorphous rate (%) corresponds to values measured in Preparation Examples 1 to 5, and Comparative Preparation Examples 1 to 10, which were amorphous soft magnetic alloys before firing soft magnetic alloy materials.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

100, 200, 300: inductor
110, 210, 310: body
120: support member
130, 230, 330: coil
131: upper coil
132: lower coil
133, 231, 331: insulating layer
140: via
150, 250: core
161, 162, 261, 262, 361, 362: external electrode
11: coarse powder magnetic particle
12: fine powder magnetic particle
20: resin

What is claimed is:

1. A soft magnetic alloy material, comprising:
Nanocrystals and amorphous phase, and
Fe (iron), Co(cobalt), and P (phosphorus),
wherein the soft magnetic alloy material is represented by Composition Formula 1,
the soft magnetic alloy material satisfies Co(c)−Co(a)>0, when an average content of Co in the amorphous phase is Co(a) (at %) and an average content of Co in the nanocrystal,
FeₐCo_{b}P_{c}M_{d} Composition Formula 1
wherein, in Composition Formula 1, a, b, c, and d represent an atomic percentage content (at %) of corresponding elements, respectively, 0<a≤90, 0<b≤20, 0<c≤10, 0<d≤20, a+b+c+d=100, and
M includes at least one selected from the group consisting of Si, B, Cu, Cr, C, Ni, Al, Mn, Ag, Zn, Sn, As, Sb, Bi, N, O, S, and combinations thereof.

2. The soft magnetic alloy material of claim 1, wherein
the soft magnetic alloy material satisfies P(a)−P(c)>0, when an average P content in the amorphous phase is P(a) (at %) and an average P content in the nanocrystal is P(c) (at %).

3. The soft magnetic alloy material of claim 1, wherein the soft magnetic alloy material satisfies 0.4≤Co(c)−Co(a)≤1.5.

4. The soft magnetic alloy material of claim 2, wherein the soft magnetic alloy material satisfies 0.5≤P(a)−P(c)≤2.5.

5. The soft magnetic alloy material of claim 1, wherein, in Composition Formula 1, 2≤b≤16.

6. The soft magnetic alloy material of claim 1, wherein, in Composition Formula 1, 1≤c≤6.

7. The soft magnetic alloy material of claim 1, wherein, in Composition Formula 1, M does not include Nb.

8. The soft magnetic alloy material of claim 1, wherein
an average crystal size of the nanocrystal is less than or equal to about 20.

9. A soft magnetic alloy material, comprising
nanocrystals and amorphous phase, and
Fe (iron), Co(cobalt), and P (phosphorus),
wherein
the soft magnetic alloy material is represented by Composition Formula 1, and
the soft magnetic alloy material satisfies P(a)−P(c)>0, when an average P content in the amorphous phase is P(a) (at %) and an average P content in the nanocrystal is P(c) (at %),
FeₐCo_{b}P_{c}M_{d} Composition Formula 1
wherein, in Composition Formula 1, a, b, c, and d represent an atomic percentage content (at %) of corresponding elements, respectively, 0<a≤90, 0<b≤20, 0<c≤10, 0<d≤20, a+b+c+d=100, and
M includes at least one selected from the group consisting of Si, B, Cu, Cr, C, Ni, Al, Mn, Ag, Zn, Sn, As, Sb, Bi, N, O, S, and combinations thereof.

10. The soft magnetic alloy material of claim 9, wherein
the soft magnetic alloy material satisfies Co(c)−Co(a)>0, when an average content of Co in the amorphous phase is Co(a) (at %) and an average content of Co in the nanocrystal.

11. The soft magnetic alloy material of claim 9, wherein the soft magnetic alloy material satisfies 0.5≤P(a)−P(c)≤2.5.

12. The soft magnetic alloy material of claim 10, wherein the soft magnetic alloy material satisfies 0.4≤Co(c)−Co(a)≤1.5.

13. The soft magnetic alloy material of claim 9, wherein, in Composition Formula 1, 2≤b≤16.

14. The soft magnetic alloy material of claim 9, wherein, in Composition Formula 1, 1≤c≤6.

15. The soft magnetic alloy material of claim 9, wherein, in Composition Formula 1, M does not include Nb.

16. The soft magnetic alloy material of claim 9, wherein an average crystal size of the nanocrystal is less than or equal to about 20.

17. A method of preparing a soft magnetic alloy material, comprising
mixing raw materials;
melting the mixed raw materials;
preparing an amorphous soft magnetic alloy by rapidly cooling the molten raw materials; and
heat-treating the amorphous soft magnetic alloy.

18. The method of claim 17, wherein
an amorphous rate of the amorphous soft magnetic alloy is greater than or equal to about 95%.

19. An inductor, comprising
a body including a magnetic material including the soft magnetic alloy material according to claim 1;
a coil in the body; and
an external electrode on the outer surface of the body.

20. The inductor of claim 19, wherein
the coil includes a support member, and an upper coil and a lower coil respectively on upper and lower surfaces of the support member, and
the upper coil and the lower coil are electrically connected through vias penetrating the support membered.

21. The inductor of claim 19, wherein
the body includes a mold portion; a cover portion on one surface of the mold portion; and a core protruding from one surface of the mold portion,
wherein the coil is between one surface of the mold portion and the cover portion, and the core penetrates through the coil.

22. The inductor of claim 19, wherein
the body includes a plurality of magnetic sheets including the magnetic material.
